(19) United States
(12) Patent Application Publication
(10) Pub. No.: US 2007/0187275 A1
(43) Pub. Date: Aug. 16, 2007

(54) Heat-shrinkable bags comprising an electronically detectable label and packages obtained therefrom

(76) Inventors: Fabrice Roy, Saint Nom la Breteche (FR); Francois-Xavier Meric, Rambouillet (FR); Stefano Santagostino, Cornaredo (IT)

Correspondence Address: Sealed Air Corporation, P.O. Box 464, Duncan, SC, 29334, US

(21) Appl. No.: 11/707,322

(22) Filed: Feb. 16, 2007

(30) Foreign Application Priority Data
Feb. 10, 2006 (EP) 06290249.9

(51) Int. Cl. B65D 65/00; B65D 81/20; G08B 13/14

(52) U.S. Cl. 206/497; 340/571; 206/524.8

(57) ABSTRACT

The present invention relates to a heat-shrinkable bag for the vacuum packaging of products, preferably food products, comprising an electronically detectable label applied onto one of its inner walls for the traceability and/or theft control of the product being packaged. A method for making heat-shrinkable bags comprising an electronically detectable label applied onto one of the inner walls from a folded web of a heat-shrinkable film is also disclosed.

The present invention relates to heat-shrinkable bags for the vacuum packaging of products, preferably of food products. In particular the present invention relates to bags provided with an electronically detectable label applied onto one of its inner walls for the traceability and/or theft control of the product packaged in said bag.

### BACKGROUND OF THE INVENTION

Electronic article security systems are widely used to deter and control theft from retail stores. Among these security systems adhesive labels comprising electronically detectable systems such as passive electronic circuits or magnetic strips which set off an alarm at the exit of the store if not deactivated, eg. at the check-out lane, are widely known.

Also known are labels which comprise a memory chip on which informations regarding the product being sold may be stored, such as inventory information, use-by-date information and the like.

For simplicity both types of labels will be herein referred to as “electronically detectable labels”.

Several proposals have been made to conceal or trap said labels in the package in order to reduce the risk of tampering or removal of the label from the object being sold. For instance EP-A-1,275,493 describes a method wherein an anti-theft device in the form of a label is positioned between the plies of a flat bag preferably in correspondence of a strengthening inlay in the area which serves for hanging the package from a display. EP-A-1,054,369 describes a method wherein the anti-theft label is positioned onto a thermoplastic sleeve which is then shrunk, generally only in the transversal direction, around a product like a bottle or a can. However there is still the need to provide a heat-shrinkable bag for the vacuum packaging of products, in particular food products, provided with an electronically detectable label which can not be removed or tampered with without destroying the final package.

### DISCLOSURE OF THE INVENTION

Thus a first object of the present invention is a heat-shrinkable bag for the vacuum packaging of products comprising an electronically detectable label adhered on one of the interior walls of said bag.

The term “vacuum packaging” is used herein to refer to a method of packaging wherein shrinkage of the packaging material over a contained product is conducted after vacuum sealing the package, that is sealing of the package once the interior of said package has been evacuated.

The heat-shrinkable bag of the present invention is made of a biaxially oriented, heat-shrinkable film. Biaxially oriented heat-shrinkable films are Is typically made by extruding or co-extruding polymers from a melt into a thick film, followed by a quick quenching and by orientation of the thick film by stretching it under temperature conditions where molecular orientation of the film occurs and the film does not tear. Upon subsequent re-heating at a temperature close to the orientation temperature the film will tend to shrink, seeking to recover its original dimensional state. Biaxially oriented heat-shrinkable films can be obtained by extruding or co-extruding the polymer(s) through a round die giving a tubular thick film called “tape”, that is immediately and quickly quenched by means of a water bath or cascade typically to about room temperature. Said tape is then heated at the orientation temperature and stretched biaxially, while at this temperature, e.g. by the so-called “trapped bubble” technique that uses internal gas pressure to expand the diameter of the tape to form a large “bubble” and advancing the expanded tube at a faster rate than the extrusion rate so as to obtain transverse and machine directions of orientation respectively. Usually the stretch is at least about 3 times in each direction. The film is then cooled and rolled up in the cooled state so as to retain the property of heat-shrinkability. The orientation temperature range generally depends on the type of polymers employed. The orientation temperature used for the manufacture of heat-shrinkable films is in any case lower than the melting temperature of at least one polymer present in the film. Alternatively biaxially oriented heat-shrinkable films can be obtained by extruding the polymers through a flat die in the form of a sheet, and after a quenching step, heating the sheet to the orientation temperature and stretching it. Longitudinal orientation is generally obtained by running the sheet over at least two series of pull rolls wherein the second set runs at a higher speed than the first one. Cross-wise or transversal orientation is generally done in a tenter frame where the edges of the sheet are grasped by clips carried by two continuous chains running on two tracks that move wider apart as they go along. In alternative to a sequential stretching, i.e. either longitudinal first and then transversal or vice-versa, the stretching may be simultaneous in both directions. The stretched film is then cooled and rolled up as usual. Also in the case of orientation by a tenter frame the stretch is usually at least about 3 times in each direction, but higher ratios are common.

The films used for the manufacture of the heat-shrinkable bags of the invention will typically have multiple layers, the different layers providing the films with the physical and the mechanical properties required. In general, the films used for the manufacture of the heat-shrinkable bags of the invention will have a total thickness up to 150 μm, preferably up to 100 μm and even more preferably up to 95 μm. Typically, the films have thicknesses from 25 to 150 μm, preferably from 35 to 100 μm and more preferably from 35 to 95 μm.

Generally the heat-shrinkable bag will shrink of from 25 to 35%, preferably 30 to 35%, in the longitudinal direction and of from 30 to 45%, preferably 38 to 45%, in the transversal direction when heated at 85° C.

Electronically detectable labels are generally in the form of thin laminates comprising at least one thermoplastic layer, a pressure sensitive adhesive laminated on one side of said thermoplastic layer and an electronically detectable element attached on the other side of the thermoplastic layer. Optionally a second thermoplastic layer is laminated onto the first one so that the electronically detectable element is sandwiched between the two thermoplastic layers.

Generally the labels are supplied as rollstock, being peelably attached to a continuous web of a suitable material.

Typical sizes of electronically detectable labels suitable for the heat-shrinkable bag of the invention are in the range of 5 to 35 cm², 8 to 30 cm², preferably 10 to 25 cm².

Electronically detectable labels may perform as theft control devices, setting off an audible alarm if not deactivated before passing through a suitable receiving device, for instance at the exit of the store. In this case the electronically detectable element is in the form of a thin magnetic strip or of a passive electronic circuit. Alternatively, the electronically detectable labels may be used to store information regarding the origin, manufacturing cycle, shelf-life of the product which can be stored and/or retrieved during the distribution cycle. In this case the electronically detectable element comprises a memory chip. Electronically detectable labels may also monitor and record information relating to the temperature of storage of the product throughout its life-cycle.

Suitable electronically detectable labels are for instance those sold by Checkpoint Meto Group under the trade name Food Safe.

A second object of the present invention is a method of manufacturing a plurality of heat-shrinkable bags comprising an electronically detectable label adhered on one of the internal walls of each one of said bags. In a first step a web of a heat-shrinkable film folded along the longitudinal direction, and comprising first and second superposed plies extending between a first marginal fold and an open edge, is unwound from a roll and fed along the machine direction to a station wherein said first and second plies are separated at the open edge to an extent sufficient to introduce an electronically detectable label between the two plies. The electronically detectable label is then applied using conventional devices to the interior wall of one of said first or second ply through the open edge. This step is followed by an impulse sealing step wherein the side seals of the bag are formed in a way that at least one label is comprised in each one of the bags. Next the film web is partially cut parallel to the seals so that a serrated cut is formed between the seal of a first bag and the seal of the bag following said first bag. The precut serrated chain of bags can be directly wound onto a roll or, alternatively it can go through a bag separation station and the formed bags are placed and aligned on a conveyor belt forming a bag chain that can be eventually taped and boxed.

In an alternative embodiment of the method of the present invention, the web of heat-shrinkable film for making the heat-shrinkable bags can be provided in the form of a flattened tube which is slit open before the label applying station.

The labels are generally provided in the form of a continuous roll from which individual labels are detached.

The label applying step is carried out using conventional label applying equipment. Minor modifications to the equipment may be introduced, such as a thinner applicator to be able to insert the individual electronically detectable labels between the two plies of the folded web of heat-shrinkable film.

A third object of the present invention is a vacuum packaged product comprising a product enclosed in a bag, said bag being heat-shrunk around said product, characterized in that an electronically detectable label is adhered on one of the internal walls of said heat-shrunk bag.

The vacuum packaged product can be obtained in any of the conventional methods for vacuum shrink packaging. For instance, according to a well-known method, a product is first placed in a heat-shrinkable bag comprising an electronically detectable label applied onto one of its internal walls; then the bag is placed in a vacuum chamber followed by vacuumizing and in-chamber sealing and finally the bag is heat shrunk to bring it intimately into contact with the article therein either in a hot water bath or a hot air tunnel.

Those skilled in the art will understand that a package can have various shapes; can have rounded, straight or irregular edges; one or more of these are typically heat sealed.

The heat-shrinkable bags of the invention can be used for the packaging of any type of products, although they are especially suited for the packaging of food products, like cheese, processed meat, poultry or fresh red meat. In this respect the thermoplastic materials making up the electronically detectable label should comply with applicable regulations relating to food contact of materials.

The product thus obtained, depending on the nature of the electronically detectable label, is protected against theft and/or provided with important information regarding its origin, its manufacturing or distribution history or shelf-life. Furthermore as the electronically detectable label is placed on the inside of the package, tampering with the label or removal of the same is not possible without destroying the package. The bags of the present invention offer also an additional advantage in that no label applying step has to be carried out during the packging operations.

1. Heat-shrinkable bag for the vacuum packaging of products comprising an electronically detectable label adhered on one of the interior walls of said bag.

2. The bag according to claim 1 comprising two side seals.

3. A method of manufacturing a plurality of heat-shrinkable bags comprising an electronically detectable label adhered on one of the internal walls of each one of said bags comprising the steps of: feeding along a machine direction a web of a heat-shrinkable film folded along the longitudinal direction, said web comprising first and second superposed plies extending between a first marginal fold and an open edge; separating said first and second plies at the open edge to an extent sufficient to introduce an electronically detectable label between the two plies; applying said electronically detectable label to the interior wall of one of said first or second ply through the open edge; downstream of said label applying station transversely sealing and cutting said web along a plurality of regularly spaced transverse seal lines so that at least one electronically detectable label is comprised in each bag.

4. The method according to claim 3 wherein the web is partially cut and the plurality of transverse-sealed bags form a pre-cut serrated chain of bags.

5. A vacuum packed product comprising a product enclosed in a bag, said bag being heat-shrunk around said product, characterized in that an electronically detectable label is adhered on one of the internal walls of said heat-shrunk bag.

6. A vacuum packed food product according to claim 5.
